(19) United States
(12) Patent Application Publication
(10) Pub. No.: US 2026/0319347 A1
(43) Pub. Date: Oct. 15, 2026

(54) ACCESSORY MOUNT, ACCESSORY, CAMERA MOUNT, AND IMAGE PICKUP APPARATUS

(71) Applicant: CANON KABUSHIKI KAISHA, Tokyo (JP)

(72) Inventor: HAJIME INOUE, Kanagawa (JP)

(21) Appl. No.: 19/570,322

(22) Filed: Mar. 18, 2026

(30) Foreign Application Priority Data
Apr. 14, 2025 (JP) 2025-066020

(51) Int. Cl. G03B 17/56; G03B 17/14

(52) U.S. Cl. CPC G03B 17/566; G03B 17/14; G03B 17/565; G03B 2217/007; G03B 2217/18

(57) ABSTRACT

An accessory mount may be attachable to and detachable from a camera mount. The accessory mount may include a second terminal portion configured to contact a first terminal portion of the camera mount while the accessory mount is attached to the camera mount, and a holder configured to hold the second terminal portion. The second terminal portion may include a plurality of terminals configured to contact only a part of a plurality of terminals of the first terminal portion. The holder may include a conductive portion configured to contact, while the accessory mount is attached to the camera mount, a first terminal among the plurality of terminals of the first terminal portion that does not contact the plurality of terminals of the second terminal portion.

### BACKGROUND

### Field of the Technology

The present disclosure relates to an accessory mount, an accessory, a camera mount, and an image pickup apparatus.

### Description of the Related Art

Japanese Patent Application Laid-Open No. 2018-205733 discloses an accessory apparatus attachable to and detachable from an image pickup apparatus.

### SUMMARY

An accessory mount according to one aspect of the present disclosure may be attachable to and detachable from a camera mount. The accessory mount may include a second terminal portion configured to contact a first terminal portion of the camera mount while the accessory mount is attached to the camera mount, and a holder that holds the second terminal portion. The second terminal portion may include a plurality of terminals that contact only a part of a plurality of terminals of the first terminal portion. The holder may include a conductive portion that, while the accessory mount is attached to the camera mount, contacts a first terminal among the plurality of terminals of the first terminal portion that does not contact the plurality of terminals of the second terminal portion. An accessory, a camera mount, and an image pickup apparatus each having the above accessory mount also constitute another aspect of the present disclosure.

Features of the present disclosure will become apparent from the following description of embodiments with reference to the attached drawings. The following description of embodiments will be described by way of example.

### BRIEF DESCRIPTION OF THE DRAWINGS

FIG. 1 is a system diagram illustrating an accessory apparatus that can be attached to a camera body according to each embodiment.

FIG. 2 is a block diagram of a camera system including a first interchangeable lens and a camera body according to each embodiment.

FIG. 3 is a block diagram illustrating an internal configuration of the camera system in which the first interchangeable lens according to each embodiment is connected to the camera body.

FIGS. 4A and 4B are explanatory diagrams of a camera mount A and a lens mount B according to a first embodiment.

FIGS. 5A, 5B, and 5C are explanatory diagrams of connection states between respective terminals due to relative rotation between the camera mount A and the lens mount B according to each embodiment.

FIG. 6 is an explanatory diagram of a lens mount B according to a second embodiment.

FIG. 7 is an exploded perspective view illustrating an example of a mount unit according to each embodiment.

### DESCRIPTION OF THE EMBODIMENTS

Referring now to the accompanying drawings, a detailed description will be given of embodiments according to the present disclosure.

### FIRST EMBODIMENT

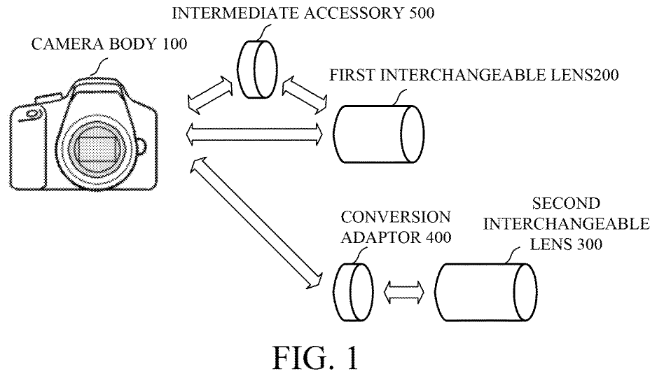

First, with reference to FIG. 1, a connection example between an image pickup apparatus employing a lens interchange system according to a first embodiment of the present disclosure and accessories (accessory apparatuses) attachable to and detachable from the image pickup apparatus will be described. FIG. 1 is a system diagram illustrating, by way of example, types of accessories that can be attached to a camera body (image pickup apparatus) 100 according to the present embodiment. The accessories in the present embodiment include an interchangeable lens, a conversion adapter, an intermediate accessory, and the like, each provided with an accessory mount (mount apparatus) that can be coupled to a camera mount provided on the image pickup apparatus. More Specifically, the accessory mount includes a plurality of accessory concave portions and accessory claws that are engageable with a plurality of camera claws and camera concave portions arranged sequentially in a circumferential direction approximately orthogonal to the optical axis on the camera mount. The accessory mount is movable from a fitted state, in which the claws and concave portions of the respective mounts are fitted to each other, to an engaged state, in which the claws engage with each other in a direction parallel to the optical axis (simply referred to as an optical-axis direction hereinafter). The fitted state corresponds to an accessory attachment start state described later, and the engaged state corresponds to an accessory attachment completion state described later. An apparatus having the camera mount is not limited to the image pickup apparatus, and may be an apparatus for performing firmware updates of a lens by connection to a PC, a measurement apparatus, or an adapter, extender, extension tube, or the like.

With reference to FIG. 1, accessories connectable to the camera body 100 will be described. A first interchangeable lens 200 is one of the accessories that can be directly attached to the camera body 100, and includes a lens mount B (second mount portion) as an accessory mount that can be directly coupled to a camera mount of the camera body 100 described later. Instead of a coupling structure (a structure including a coupling portion), another fixing method such as a contact portion with the camera mount may be used. A housing portion (holder) and the coupling portion may be provided as separate members.

An intermediate accessory 500 is another one of the accessories that can be directly attached to the camera body 100. The intermediate accessory 500 includes a lens mount B as an accessory mount that can be directly attached to the camera body 100, and a camera mount A (first mount portion) that can be directly attached to the first interchangeable lens 200. That is, the first interchangeable lens 200 may be connected to the camera body 100 via the intermediate accessory 500.

A second interchangeable lens 300 can be indirectly attached to the camera body 100 via a conversion adapter 400 that can be directly attached to the camera body 100. That is, a lens mount D, which is an accessory mount provided on the second interchangeable lens 300, cannot be directly attached to the camera mount A (first mount portion) provided on the camera body 100. A camera mount C provided on the conversion adapter 400 can be directly coupled (attached) to the lens mount D of the second interchangeable lens 300.

As described above, the camera body 100 can be attached to the first interchangeable lens 200, the first interchangeable lens 200 via the intermediate accessory 500, and the second interchangeable lens 300 via the conversion adapter 400. Hereinafter, a common description applicable to the first interchangeable lens 200 and the second interchangeable lens 300 will be given by collectively referring to the first interchangeable lens 200 and the second interchangeable lens 300 as interchangeable lenses (lens apparatuses). Similarly, the conversion adapter 400 and the intermediate accessory 500 will be collectively referred to as adapters.

### BASIC CONFIGURATION OF CAMERA BODY 100 AND FIRST INTERCHANGEABLE LENS 200

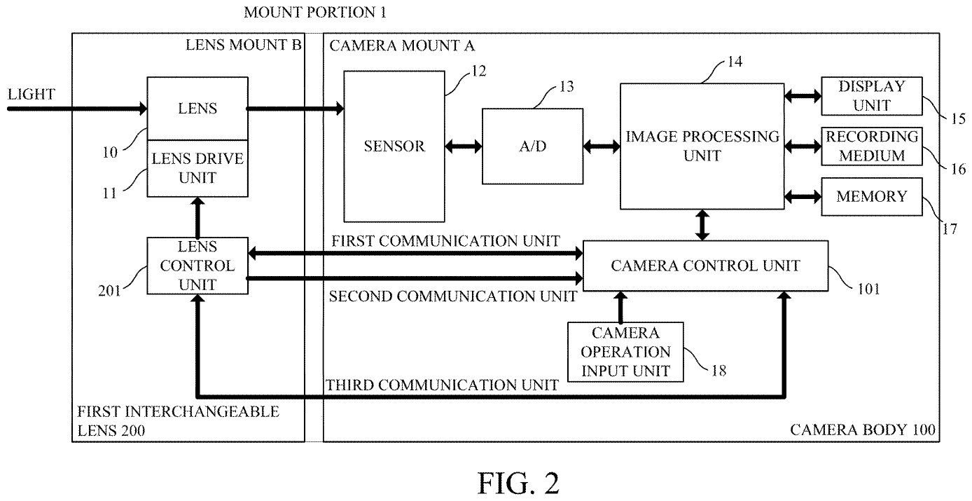

Next, with reference to FIG. 2, a basic configuration of the camera body 100 and the first interchangeable lens 200 will be described. FIG. 2 is a block diagram illustrating, by way of example, a camera system (imaging system) including the first interchangeable lens 200 and the camera body 100 to which the first interchangeable lens 200 can be directly coupled (attached and detached). In FIG. 2, both mounts provided on the first interchangeable lens 200 and the camera body 100 will be collectively referred to as a mount unit 1. Details of the mounts provided on the first interchangeable lens 200 and the camera body 100 will be described later. In the present embodiment, the image pickup apparatus (such as the camera body 100) and the accessory (such as the first interchangeable lens 200) are attachable to and detachable from each other.

The camera body 100 is an image pickup apparatus represented by a digital camera. As illustrated in FIG. 2, the camera body 100 includes a charge-accumulation-type imaging sensor (image pickup element) 12 that photoelectrically converts an optical image of an object guided by a lens 10 provided inside the first interchangeable lens 200 and outputs an electrical signal. The camera body 100 further includes an A/D converter 13 that converts an analog electrical signal output from the image sensor 12 into a digital signal, and an image processing unit 14 that generates a video signal by performing various types of image processing on the digital signal. The video signal (still or moving images) generated by the image processing unit 14 can be displayed on a display unit 15 and recorded on a recording medium 16.

The camera body 100 further includes a memory 17 that functions as a buffer when processing the video signal and stores an operation program used by a camera control unit 101 described later.

The camera body 100 further includes a camera operation input unit 18 including a power switch for turning the power on and off, an imaging switch (release switch) for starting recording of a video signal, and selecting/setting switches for setting a variety of menus. The camera body 100 further includes a camera control unit 101 including a microprocessor (CPU) that comprehensively controls operations of the camera body 100 and accessories attachable to the camera body 100. The camera control unit 101, for example, performs a variety of settings based on signals input from the camera operation input unit 18, or controls communication with a lens control unit 201 provided in the first interchangeable lens 200 via the mount unit 1.

On the other hand, the first interchangeable lens 200 includes the lens 10 that is an optical member including a plurality of lens units such as a zoom lens, a shift lens, and a focus lens, and a light amount adjustment member such as an aperture stop. The first interchangeable lens 200 further includes actuators for moving or operating the plurality of lens units and the aperture stop, and a lens driving unit 11 that drives the actuators. The first interchangeable lens 200 further includes the lens control unit 201 including a microprocessor (LCPU) for lenses that comprehensively controls operations of the first interchangeable lens 200. The lens control unit 201, for example, controls communication with the camera control unit 101 via the mount unit 1, or controls the lens driving unit 11.

### BASIC CONFIGURATION OF ELECTRICAL TERMINALS

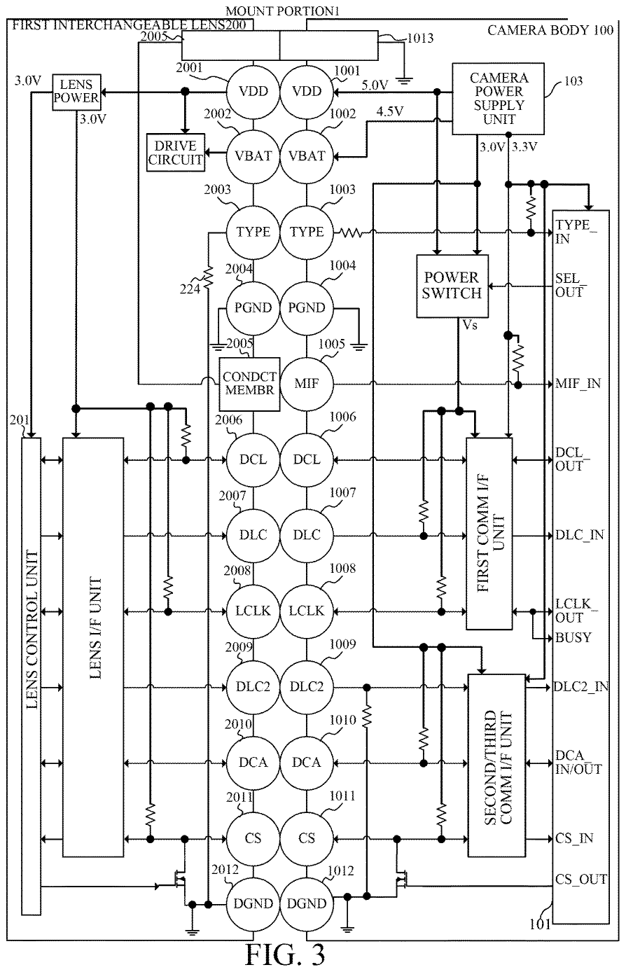

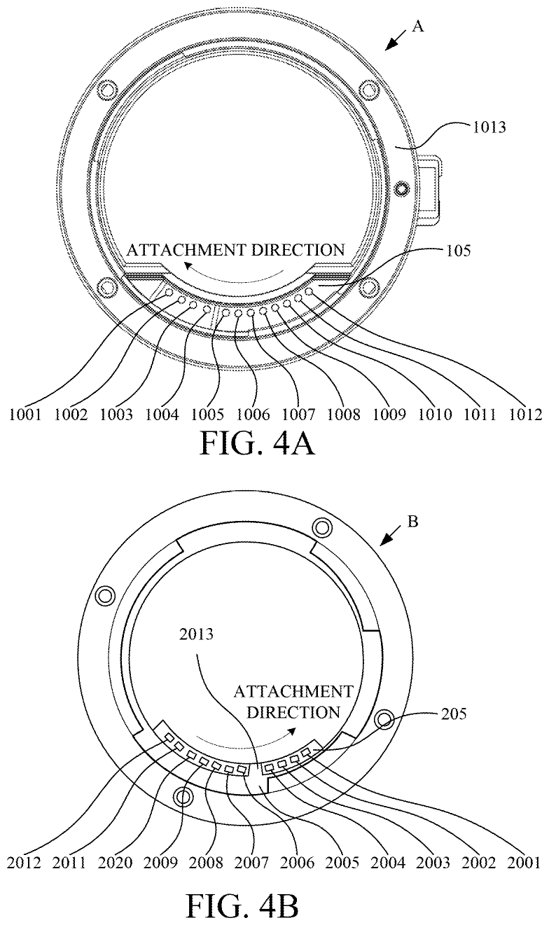

Next, with reference to FIGS. 3, 4A, and 4B, the internal configuration of the camera system in the connection state between the camera body 100 and the first interchangeable lens 200 will be described. FIG. 3 is a block diagram illustrating, by way of example, the internal configuration of the camera system in the connection state between the first interchangeable lens 200 and the camera body 100. The camera mount and the lens mount include a lock mechanism, a mount holding mechanism, and a plurality of electrical terminals. Details of each mount will be described later. FIGS. 4A and 4B are diagrams illustrating, by way of example, the configurations of the camera mount A and the lens mount B according to the present embodiment. FIG. 4A is a front view of the camera mount A provided on the camera body 100, and FIG. 4B is a front view of the lens mount B provided on the first interchangeable lens 200.

As illustrated in FIG. 3, the mount unit 1 includes a plurality of terminals that enable electrical connection between the camera body 100 and the first interchangeable lens 200. In the camera body 100, the plurality of terminals (camera-side terminals) are exposed to the outside of the camera body 100 as a plurality of electrical contact pins provided on a contact holding member 105 corresponding to a terminal holder of the ring-shaped camera mount A (FIG. 4A). In the first interchangeable lens 200, the plurality of terminals (accessory-side terminals) are exposed to the outside of the first interchangeable lens 200 as a plurality of electrical contact surfaces provided on a terminal holder (holder) 205 of the ring-shaped lens mount B (FIG. 4B). The electrical contact pins and the electrical contact surfaces on the camera body 100 side and the first interchangeable lens 200 side are electrically connected to corresponding contacts while the first interchangeable lens 200 is attached to the camera body 100.

In the present embodiment, as will be described later, each mount includes a step having a different height in the optical-axis direction (central axis direction of the mount) such that contact positions of corresponding terminals differ in the optical-axis direction among a plurality of terminals formed on each mount. That is, the plurality of terminals include two terminals that are adjacent to each other and have different heights. Here, “adjacent” means that two terminals among the plurality of terminals (for example, terminals 2004 and 2006) are adjacent to each other, and another member (such as a conductive member) may be present between them. These plurality of terminals are unitized as a single component, and the terminals in each mount are connected to a flexible printed circuit (board) (FPC) as a single wiring portion.

In the present embodiment, a single-unit structure of the camera mount A in the camera body 100 has been described. However, also in other mounts described later, it is common that a plurality of terminals are electrically connected to at least a single FPC (wiring).

Due to this configuration, compared with a case where terminal portions of each mount are divided into a plurality of units and distributed in the circumferential direction of the mount, all terminals can be collectively arranged at positions farther from an exposure aperture provided in front of the image sensor 12. Therefore, for example, when unnecessary light enters the camera mount side while the accessory is mounted on the camera body 100, the influence of unnecessary light reflected by terminals formed of metal members on object imaging can be reduced. By forming the terminals as a single unit, wiring inside the image pickup apparatus and accessories can be simple, and assembly during mount assembly can be facilitated.

Next, functions of the terminals common to both the camera mount A and the lens mount B will be described. VDD terminals 1001 and 2001 are terminals for supplying, from the camera body 100 to an accessory (for example, the first interchangeable lens 200), a communication control power supply (VDD) as communication power mainly used for communication control. The voltage of the power supplied to the first interchangeable lens 200 is 5.0 V.

VBAT terminals 1002 and 2002 are terminals for supplying, from the camera side to the accessory side, a driving power supply (VBAT) as driving power used for operation of mechanical driving portions of actuators used to drive an aperture and focus lenses. In other words, the VBAT terminals 1002 and 2002 are terminals used to supply power other than the communication power. The voltage of the power supplied to the first interchangeable lens 200 is 4.5 V. The VDD terminals and the VBAT terminals described above are power-supply terminals for supplying power from the camera body 100 to the accessory. The voltage supplied to the VBAT terminals may be changeable by changing an output setting of a power supply circuit in accordance with the type of accessory mounted on the camera body 100.

D-GND terminals 1012 and 2012 are ground terminals corresponding to the communication control power supply VDD. That is, the D-GND terminals 1012 and 2012 indicate ground levels (voltages) corresponding to predetermined terminals. In the present embodiment, grounding means setting the voltage level of a ground terminal to be substantially the same level (ground level) as a negative side of a power supply such as a battery.

P-GND terminals 1004 and 2004 are terminals indicating ground levels corresponding to terminals of mechanical drive systems including motors (actuators) provided on the camera body 100 and the accessory (for example, the first interchangeable lens 200). That is, the P-GND terminals are ground terminals corresponding to the driving power supply VBAT. The D-GND terminals and the P-GND terminals described above are ground terminals for grounding various power systems of the camera body 100 and the accessory to a ground level.

An MIF terminal 1005 is a terminal (first terminal) for detecting that an accessory (for example, the first interchangeable lens 200) is attached to the camera body 100. The camera control unit 101 detects that an accessory is attached to or detached from the camera body 100 by detecting a voltage level indicated by the MIF terminal. Based on this detection, the camera control unit 101 controls, for example, to start supplying power to power-supply terminals after detecting attachment of the accessory, and to start communication between the camera body 100 and the accessory. That is, the MIF terminal 1005 is a terminal for detecting that an accessory is attached to the camera body 100, for enabling the camera body 100 to start communication with the accessory, and for enabling the camera body 100 to start supplying power to the accessory.

The first interchangeable lens 200 includes a mount housing (housing unit, coupling unit) that can be coupled to a mount housing (metal portion) 1013 of the camera body 100. The mount housing includes a conductive member (conductive portion) 2005. When the first interchangeable lens 200 is attached to the camera body 100, the conductive member 2005 electrically connects the mount housing (metal portion) 1013 of the camera body 100 and the MIF terminal 1005. By establishing electrical continuity with the mount housing 1013 that is connected to ground (GND) of the camera body 100, the voltage level indicated by the MIF terminal 1005 is set to low (Lo), thereby detecting that the first interchangeable lens 200 is attached. Prior art provides a terminal on the lens mount B to detect that the first interchangeable lens 200 is mounted on the camera body 100. In the present embodiment, this terminal is omitted. That is, in the present embodiment, a terminal corresponding to the first terminal (1005) among the plurality of terminals (1001 to 1012) of the first terminal portion is not provided in the second terminal portion. By using the conductive member 2005 to establish electric connection between the MIF terminal 1005 and the mount housing 1013, an accessory can be achieved with a simple configuration, and cost can be reduced. In the present embodiment, the conductive member 2005 has a shape (size) different from those of the plurality of terminals of the first interchangeable lens 200, but may have the same shape as those of the other terminals.

As described above, in the present embodiment, the conductive member 2005 is not grounded while the first interchangeable lens 200 is not attached to the camera body 100. While the first interchangeable lens 200 is not attached to the camera body 100, the conductive member 2005 is not connected to a ground terminal (GND) via a resistor. The conductive member 2005 is grounded when the first interchangeable lens 200 is attached to the camera body 100.

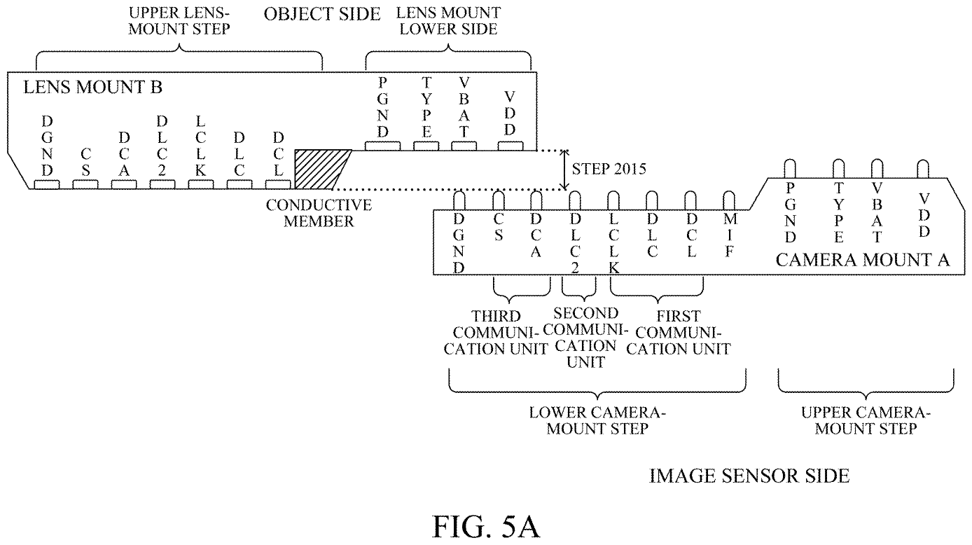

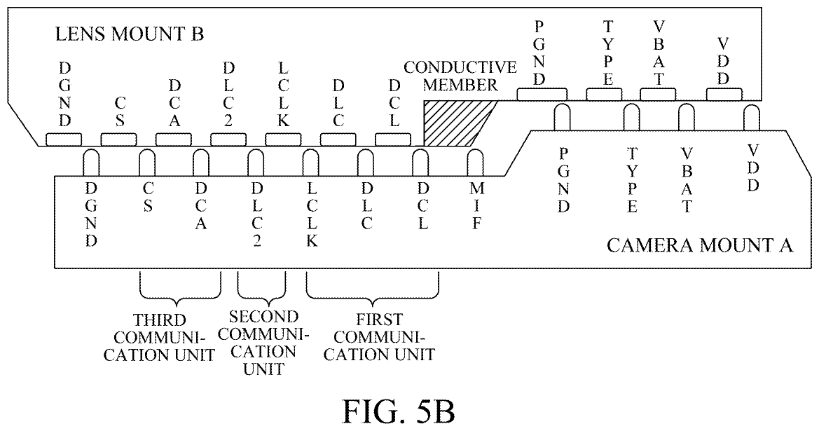

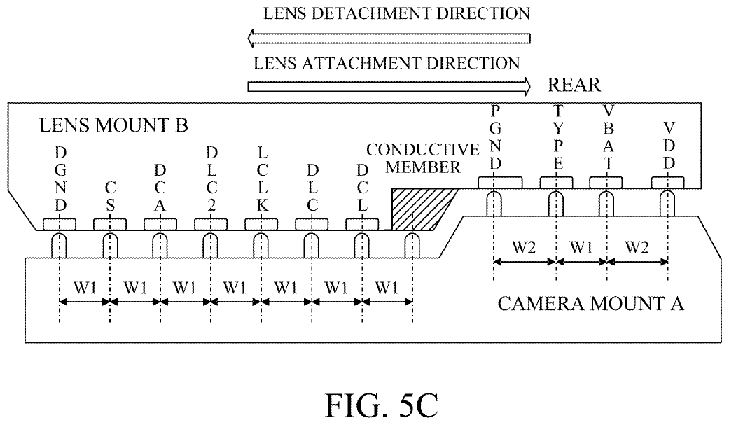

Next, with reference to FIGS. 4B, 5A, 5B, and 5C, fitting between the terminal holder 205 and the conductive member 2005 will be described. FIGS. 5A, 5B, and 5C are diagrams illustrating, by way of example, connection states between terminals due to relative rotation between the camera mount A and the lens mount B. FIG. 5A illustrates an attachment start state of the camera mount A and the lens mount B, FIG. 5B illustrates an attachment transition state, and FIG. 5C illustrates an attachment completion state. FIGS. 5A, 5B, and 5C illustrate states in which terminals provided on each mount are viewed from a direction orthogonal to the optical axis of the camera mount A and the lens mount B. Here, the optical axis described above is parallel to a central axis passing through centers of openings of the camera mount A and the lens mount B.

The camera mount A includes a first terminal portion including a plurality of terminals (1001 to 1012). The lens mount B includes a second terminal portion (2001 to 2004 and 2006 to 2012) used for electrical connection with the terminal portion provided on the camera mount A. The plurality of terminals in each of the first terminal portion and the second terminal portion are arranged along circumferential directions of the first mount portion or the second mount portion (arranged on the same circumference as the first mount portion or the second mount portion).

The terminal holder 205 includes a space 2013 for fitting with the conductive member 2005. By fitting the conductive member 2005 into the space 2013, the conductive member 2005 can be brought into contact with the MIF terminal 1005 of the camera body 100.

TYPE terminals 1003 and 2003 are terminals for identifying the type of accessory (for example, the first interchangeable lens 200) attached to the camera body 100. The camera control unit 101 detects a voltage value of a signal indicated by the TYPE terminal, and determines, based on the detected value, the type of the accessory mounted on the camera body 100. In the first interchangeable lens 200, the TYPE terminal is pull-down connected to the D-GND terminal with a predetermined resistance value described later. The resistance value differs depending on the type of the accessory.

Next, terminals for various types of communication between the camera body 100 and the accessory will be described. The plurality of communication terminals provided in the mount unit 1 are divided into a plurality of communication systems (groups), and each communication system can perform communication independently. In the present embodiment, the LCLK terminals 1008 and 2008, the DCL terminals 1006 and 2006, and the DLC terminals 1007 and 2007 constitute a first communication unit that performs first communication. The DLC2 terminals 1009 and 2009 constitute a second communication unit that performs second communication independent of the first communication unit. The CS terminals 1011 and 2011 and the DCA terminals 1010 and 2010 constitute a third communication unit that performs third communication independently of the first and second communication units. In the present embodiment, each of the camera control unit 101 and the lens control unit 201 can perform first to third independent communications via the plurality of communication terminals described above.

The LCLK terminals 1008 and 2008 are terminals of the first communication unit, and are terminals for a communication clock signal output from the camera body 100 to the accessory, and terminals for the camera body 100 to monitor a busy state of the accessory.

The DCL terminals 1006 and 2006 are terminals of the first communication unit, and are communication data terminals for bidirectional communication between the camera body 100 and the accessory.

The DLC terminals 1007 and 2007 are terminals of the first communication unit, and are communication data terminals for data output from the accessory (for example, the first interchangeable lens 200) to the camera body 100.

The LCLK, DCL, and DLC terminals corresponding to the first communication unit described above can switch a signal output mode (method) between a so-called CMOS output type and an open type. In the present embodiment, the CMOS output type has switch outputs for both H (High) and L (Low) voltage levels. In contrast, the open type has a switch output only on the L side. The open type in the present embodiment refers to a so-called open-drain type, but may be an open-collector type.

The DLC2 terminals 1009 and 2009 are terminals of the second communication unit, and are communication data terminals for data output from the accessory (for example, the first interchangeable lens 200) to the camera body 100.

The DCA terminals 1010 and 2010 are terminals of the third communication unit, and are communication data terminals for bidirectional communication between the camera body 100 and the accessory (for example, the first interchangeable lens 200).

The CS terminals 1011 and 2011 are terminals of the third communication unit, and are signal terminals for requesting communication between the camera body 100 and the accessory (for example, the first interchangeable lens 200). In the present embodiment, in a case where the first interchangeable lens 200 is attached to the camera body 100, the communication voltage at the terminals corresponding to the first to third communication units is set to 3.0 V.

### STRUCTURE OF MOUNT UNIT 1

Next, with reference to FIGS. 4A to 5C, a structure of the mount unit 1 including the camera mount A and the lens mount B will be described.

The state illustrated in FIG. 5A is a state in which a plurality of claws provided on the camera mount A are inserted into a plurality of concave portions provided on the lens mount B, and a plurality of claws provided on the lens mount B are inserted into a plurality of concave portions provided on the camera mount A. By relatively rotating the camera mount A and the lens mount B from this state in a lens attachment direction, the state transitions to a state illustrated in FIG. 5C, in which corresponding terminals provided on both mounts are connected to each other. Here, the lens attachment direction is a direction orthogonal to a central axis of the camera mount A (and the lens mount B), and in the present embodiment indicates an attachment direction of an interchangeable lens on the basis of the camera mount A. In a case where the optical axis of the interchangeable lens coincides with the mount central axis, the lens attachment direction is orthogonal to the optical axis. In the state illustrated in FIG. 5C, relative rotation between the camera mount A and the lens mount B is restricted by a lock mechanism (not illustrated), which is a rotation restricting member provided on each mount.

The state illustrated in FIG. 5B is a state in which, between the attachment start state and the attachment completion state of the camera mount A and the lens mount B described above, only the P-GND terminals start to be connected earlier than other corresponding terminals. Details of this will be described later.

In the present embodiment, electrical terminals provided on the camera mount will be hereinafter referred to as contact pins, and electrical terminals provided on the lens mount will be referred to as contact surfaces (or contact pieces). Alternatively, the camera mount may include contact surfaces and the lens mount may be provided with contact pins.

As illustrated in FIG. 5A, the mount unit 1 according to the present embodiment has a two-step configuration including a step 2015 in the optical-axis direction (a direction parallel to the central axis of the mount unit 1). In the camera mount A of the camera body 100, a step protruding toward the object side will be referred to as an upper camera-mount step (fourth step), and a step on the imaging element side is referred to as a lower camera-mount step (third step). That is, the upper camera-mount step protrudes further toward the object side (or accessory side) in the optical-axis direction than the lower camera-mount step.

In the lens mount B of the first interchangeable lens 200, a step recessed toward the object side will be referred to as a lower lens-mount step (second step), and a step protruding toward the imaging element side (image side) when mounted on the camera mount A will be referred to as an upper lens-mount step (first step). That is, while the lens mount is attached to the camera mount, the upper lens-mount step protrudes further toward the image pickup apparatus side in the optical-axis direction than the lower lens-mount step. The lower camera-mount step (third step) corresponds to the upper lens-mount step (first step), and the upper camera-mount step (fourth step) corresponds to the lower lens-mount step (second step).

The first step is located at a first height, and the second step is located at a second height. Here, “height” is intended to mean a height from a common reference (in a global coordinate system). In other words, it does not mean heights measured from the surfaces of the respective steps (i.e., different reference levels for each step). Thus, even if a plurality of terminals (for example, an MIF terminal and a VDD terminal) have the same length (protrusion amount from a surface of a terminal holder), their heights are different. There may be three or more terminals having mutually different heights.

The first height and the second height do not need to be strictly equal heights, respectively, and variations in height are allowable as long as the terminals can contact camera-side terminals. That is, instead of the step on the accessory side corresponding to the step on the camera side, the terminals on the accessory side may have different lengths.

The terminals on the upper camera-mount step are configured to be capable of contacting only the terminals on the lower lens-mount step, and the terminals on the lower camera-mount step are configured to be capable of contacting only the terminals on the upper lens-mount step. In the camera mount A, the lower camera-mount step is located on the front side in a relative rotation direction relative to the lens mount B (accessory attachment direction), and the upper camera-mount step is located on the rear side. In the lens mount B, the upper lens-mount step is located on the front side in the relative rotation direction relative to the camera mount A, and the lower lens-mount step is located on the rear side. In the present embodiment, the conductive member 2005 is disposed at a boundary portion between the upper lens-mount step and the lower lens-mount step (between two terminals). In other words, the conductive member 2005 constitutes one of the upper lens-mount step and the lower lens-mount step.

The present embodiment provides steps on both the camera mount A and the lens mount B in order to differentiate positions (in a direction parallel to the mount central axis) at which electrical terminals are arranged. However, the configuration is not limited to this embodiment. Any configuration may be adopted as long as positions at which terminals are arranged differ in each mount. For example, a configuration may be adopted in which an inclined surface is provided so that terminal arrangement positions continuously differ in a direction parallel to the mount central axis, or a configuration may be adopted in which protrusion amounts of the terminals themselves protruding in a direction parallel to the mount central axis differ.

In the present embodiment, the camera mount A has a stepped structure (a lower camera-mount step and an upper camera-mount step); however, the terminal holder 205 of the lens mount B may not be provided with the step 2015 (that is, the terminal holder of the lens mount B may be planar in the optical-axis direction). In other words, while the camera mount A has a step, the lens mount B may not have any steps. For example, instead of providing a step, lengths of the plurality of terminals may be varied. That is, the terminals may be configured to slide against the camera-side terminals during attachment without using a driving force from a driving unit. Alternatively, for example, when the mount apparatus is attached to the camera body, among the plurality of terminals provided on the terminal holder of the lens mount, terminals that are to be connected to the terminals disposed on the lower camera-mount step may be configured to move so as to extend in the optical-axis direction (image-side direction). That is, while the lens mount is being rotated in the lens attachment direction illustrated in FIG. 5C, the terminals D-GND to DCL of the lens mount may be configured to extend toward the image side (i.e., the protrusion amount of the terminals from the terminal holder increases). In this case, the conductive member may also be configured to extend in the same manner as the other terminals. In such a configuration, when the accessory mount is attached to the camera mount, the terminal holder moves in the optical-axis direction. Instead of a configuration in which only the terminals protrude, the entire terminal holder may be configured to protrude from the housing portion. For example, the terminal holder may have a cam follower (projection) and the housing portion may have a cam groove, such that, when the lens is attached while being rotated, the terminal holder is advanced in the optical-axis direction (so that the terminals do not slide against the camera-side terminals during attachment). The above-described variation may also be combined as appropriate.

The plurality of terminals arranged on each step may not have the same height. This is because the camera-side terminals are spring-biased in the optical-axis direction, and thus height errors within a certain range can be absorbed.

As illustrated in FIG. 5C, the lens mount B moves relative to the camera mount A by rotating (in a right direction in the drawing) while the terminals provided on the lens mount B slide in contact with the corresponding terminals provided on the camera mount A. For example, when attachment of the camera body 100 and the first interchangeable lens 200 is completed, each contact pin of the camera mount A and each corresponding contact surface of the lens mount B are electrically connected independently. Hereinafter, for simple description, electrical conduction between terminals that are electrically paired (corresponding) to each other in the camera mount A and the lens mount B will be referred to as “connection,” and electrical conduction between terminals that are not electrically paired (not corresponding) will be referred to as “contact.”

In the present embodiment, a plurality of claw groups provided on the camera mount A and on the lens mount B are bayonet claws, and attachment (coupling) of the two is completed by engagement of the claw groups in the optical-axis direction using a so-called bayonet coupling method.

Next, an arrangement order of the terminals of the mount unit 1 according to the present embodiment will be described. In the present embodiment, the lens (accessory) attachment direction refers to a relative rotation (attachment) direction of the lens mount B relative to the camera mount A. Therefore, on the basis of the accessory attachment direction, among the terminals provided on the camera mount A, a side on which a terminal (VDD terminal) that contacts the terminal on the lens mount B last is located corresponds to a rear side in the lens attachment direction, and an opposite side corresponds to a front side. Among the terminals provided on the lens mount B, a side on which the terminal (VDD terminal) that contacts the terminal on the camera mount A first is located corresponds to the rear side in the lens attachment direction, and an opposite side corresponds to the front side. As illustrated in FIG. 5A, on the upper camera-mount step, the VDD terminal 1001, the VBAT terminal 1002, the TYPE terminal 1003, and the PGND terminal 1004 are arranged in this order from the rear side (terminal end) in the lens attachment direction. Here, the rear side in the lens attachment direction refers to a side on which a terminal that contacts a lens-side terminal last when the first interchangeable lens 200 is attached to the camera body 100 is located.

On the lower camera-mount step, the MIF terminal 1005, the DCL terminal 1006, the DLC terminal 1007, the LCLK terminal 1008, the DLC2 terminal 1009, the DCA terminal 1010, the CS terminal 1011, and the D-GND terminal 1012 are arranged in this order from the rear side in the lens attachment direction.

Similarly, on the lower lens-mount step, the VDD terminal 2001, the VBAT terminal 2002, the TYPE terminal 2003, and the PGND terminal 2004 are arranged in this order from the rear side in the lens attachment direction. On the upper lens-mount step, the conductive member 2005, the DCL terminal 2006, the DLC terminal 2007, the LCLK terminal 2008, the DLC2 terminal 2009, the DCA terminal 2010, the CS terminal 2011, and the DGND terminal 2012 are arranged in this order from the rear side in the lens attachment direction.

That is, four terminals are arranged on each of the upper camera-mount step and the lower lens-mount step, and eight terminals are arranged on each of the lower camera-mount step and the upper lens-mount step. The upper camera-mount step and the lower lens-mount step are configured to have fewer exposed terminals than the lower camera-mount step and the upper lens-mount step.

When attachment and detachment between the image pickup apparatus and the accessory are performed by rotating the camera mount and the lens mount relative to each other, as in a bayonet coupling method, terminals provided on each mount slide against each other during attachment and detachment. Generally, on the same plane in the optical-axis direction, a contact pin located on the rearmost side in the lens attachment direction on the camera mount side does not slide against a non-corresponding contact surface on the accessory side during attachment or detachment. On the same plane in the optical-axis direction, a contact surface located on the frontmost side in the lens attachment direction on the lens mount side does not slide against a non-corresponding contact pin on the camera side during attachment or detachment. That is, in the camera mount, a contact pin (terminal) located further to the rear than other contact pins does not slide against (contact) contact surfaces other than the corresponding contact surface in a mounted state. In the lens mount, a contact surface (terminal) located further to the front than other contact surfaces (terminals) does not slide against (contact) contact pins other than the mutually contacting contact pins while the accessory is attached to the image pickup apparatus.

However, for another terminal other than these terminals, terminal wear increases as the number of attachment and detachment operations between the lens mount and the camera mount increases. In particular, the terminals (contact pins) on the camera mount are movable pins capable of advancing and retracting in a direction parallel to the optical axis, and slide against the terminal (contact surface) of the lens mount at a single point at their tips, and durability may be improved against sliding.

This problem becomes more pronounced as the number of terminals arranged in a row on the same plane orthogonal to the optical axis increases, because the number of sliding operations between contact pins and contact surfaces increases. Wear of the contact pins and contact surfaces increases contact impedance of the terminal, a voltage drop increases, and when the voltage falls below a permissible operating voltage range of an electrical circuit, malfunction of, for example, the interchangeable lens may occur.

Accordingly, in the present embodiment, to reduce the number of sliding operations between terminals, positions at which terminals are held in the optical-axis direction are differentiated into an upper step and a lower step, and contact heights between camera-side contact pins and interchangeable-lens-side contact surfaces differ between the upper step and the lower step. Due to this configuration, wear between terminals can be reduced for each step holding the terminals.

In the present embodiment, since the number of terminals held on the upper step and the lower step differs, terminals having higher importance among a plurality of terminals are arranged on the side having fewer terminals, thereby reducing wear of important terminals. More specifically, power-supply terminals (VDD terminals, VBAT terminals, and PGND terminals), for which an increase in contact impedance is to be particularly suppressed, are arranged on the upper camera-mount step and the lower lens-mount step, which have fewer terminals. On the other hand, the lower camera-mount step and the upper lens-mount step are provided mainly with terminals for communication, which are less susceptible to the effects of impedance increases than power-supply terminals. This configuration enables stable power supply to the accessory and contributes to stabilizing operations of the accessory (for example, focus control).

The D-GND terminal 1012 in the camera mount A is located on the lower camera-mount step and is disposed at the frontmost side (start end) in the lens attachment direction, which is the most disadvantageous position for durability against sliding of camera-side contact pins. However, the D-GND terminal may be physically grounded to a metal portion formed in the camera mount in order to protect electrical circuits and elements provided in the accessory from static electricity and the like. In the present embodiment, for easy processing for the above reason, the D-GND terminal is disposed on the frontmost side in the lens attachment direction.

The present embodiment assumes a system in which a current level flowing through the D-GND terminal is smaller than that flowing through the PGND terminal. Therefore, the present embodiment provides the PGND terminal, through which a larger current flows, on the upper camera-mount step (lower lens-mount step), which has fewer terminals and is beneficial in suppressing an increase in contact impedance.

Next, the camera mount A of the present embodiment has two power-supply contact pins (the VDD terminal 1001 and the VBAT terminal 1002) as the first and second terminals when viewed from the rear side in the lens attachment direction on the upper camera-mount step. The camera mount A of the present embodiment has the TYPE terminal 1003 adjacent to the power-supply terminals. The lens mount B of the present embodiment has two power-supply contact surfaces (the VDD terminal 2001 and the VBAT terminal 2002) as the first and second terminals when viewed from the rear side in the lens attachment direction on the lower lens-mount step. The lens mount B of the present embodiment has the TYPE terminal 2003 adjacent to the power-supply terminals. The adjacent state between the terminals described above refers to a state in which the terminals are adjacent to each other on the mount.

Due to the above configuration, in the mount unit 1 according to the present embodiment, the two power-supply terminals (the VDD terminal and the VBAT terminal) and the PGND terminal are not adjacent to each other. Therefore, short circuits between the two power-supply terminals and the PGND terminal can be reduced, thereby preventing malfunction or failure of a power supply circuit provided on the camera side due to such short circuits.

The TYPE terminal 1003 disposed between the VBAT terminal 1002 and the PGND terminal 1004 is capable of protecting electrical circuits of the camera body 100 by providing a protection element on a signal line of the TYPE terminal 1003.

Here, terminals other than the TYPE terminal may also be provided with protection elements on their signal lines in the same manner as the TYPE terminal 1003, thereby enabling similar protective measures. However, as described above, since the DCL terminal, the DLC terminal, the LCLK terminal, the DLC2 terminal, the DCA terminal, and the CS terminal are communication terminals, adding protection elements to these terminals increases wiring capacitance. In this case, since an increase in wiring capacitance may disturb responsiveness such as leading and trailing edges of communication waveforms, thereby affecting communication performance, communication terminals may be provided with as few protection elements as possible in a proper configuration.

On the other hand, in the mount unit 1 according to the present embodiment, the TYPE terminal 1003 has a constant signal voltage. For example, while the first interchangeable lens 200 is mounted on the camera body 100, the signal value of the TYPE terminal 1003 does not change. Thus, even if a protection element or the like is added to the TYPE terminal 1003 in the mount unit 1 according to the present embodiment, the influence on operations executed by the camera body 100 and the first interchangeable lens 200 is small.

The MIF terminal 1005 also has a constant signal voltage, similarly to the TYPE terminal 1003, and thus may include a protection element as in the TYPE terminal 1003. However, in the mount unit 1 according to the present embodiment, the MIF terminal 1005 is not disposed adjacent to power-supply terminals. The reason for this will be described later.

Next, as illustrated in FIG. 5C, in the camera mount A and the lens mount B, an inter-terminal pitch W2 (distance) between the VDD terminal and the VBAT terminal is configured to be larger than a basic pitch W1 (W2>W1). In the camera mount A and the lens mount B, the MIF terminal and the PGND terminal are held on different steps in the optical-axis direction of each mount, and an inter-terminal pitch W3 is configured to be larger than both the basic pitch W1 and the pitch W2 (W3>W2>W1). In the present embodiment, the inter-terminal pitch refers to a distance between centers (centerlines) of respective terminals (contact pins and contact surfaces) in the attachment direction (rotation direction) of the lens mount B. Alternatively, the inter-terminal pitch may be defined as a distance between conductive portions (metal regions) provided on the terminals. In a case where the lens mount B is mounted on the camera mount A, the inter-terminal pitch may be defined as a distance between contact points (connection points) between corresponding contact pins and contact surfaces of adjacent terminals.

In the present embodiment, widths of contact surfaces of the VDD terminal 2001 and the VBAT terminal 2002 in the circumferential direction of the lens mount B are a basic width described later, but the present disclosure is not limited to the present embodiment. For example, widths of the contact surfaces of the VDD terminal 2001 and the VBAT terminal 2002 may be larger or smaller than the basic width. In this case, the pitch between the VDD terminal and the VBAT terminal may be set in consideration of a difference between the basic width and the widths of the VDD terminal 2001 and the VBAT terminal 2002. For example, in a case where the widths of the VDD terminal 2001 and the VBAT terminal 2002 are larger than the basic width toward the lens detachment direction, the pitch between the VDD terminal and the VBAT terminal may be increased by an amount corresponding to the difference from the basic width.

The above-described basic pitch is a distance between terminals that is set in consideration of play and tolerances associated with manufacturing and assembly of the camera body 100. Contact pins on the camera-mount A side for which the basic pitch is set are configured such that, unless deformation such as bending occurs or conductive foreign matter is present between terminals, a single contact surface on the lens-mount B side having the basic width described later does not simultaneously contact a plurality of contact pins. Thus, short circuits between adjacent terminals caused by a contact pin on the camera mount A contacting two or more contact surfaces on the lens mount B side can be prevented. In the following description, unless otherwise specified, it is assumed that the basic width is set to a pitch between adjacent contact pins.

The above-described basic width refers to a width of a contact surface on the lens-mount B side that is set in consideration of play and tolerances associated with manufacturing and assembly of the accessory. The width of the contact surface refers to a width of each contact surface in the attachment direction (rotation direction) of the lens mount B. As described above, a plurality of contact pins on the camera-mount A side with the basic pitch set do not simultaneously contact a single contact surface on the lens-mount B side having the basic width. Unless deformation of camera-side contact pins, conductive foreign matter, or the like is present between the contact pins, a contact surface on the lens-mount B side having the set basic width does not disengage from a contact pin on the image pickup apparatus side in the attachment state of the accessory. In the following description, unless otherwise specified, it is assumed that the basic width is set to the widths of contact surfaces.

The inter-terminal pitch between the VDD terminal 1001 and the VBAT terminal 1002 on the camera side in the present embodiment is set to be wider than the widths of the VDD terminal 2001 and the VBAT terminal 2002 on the accessory side having the set basic width by approximately 3° in consideration of downsizing of the unit and power-supply safety. Due to this configuration, even if deformation of the VDD terminal or the VBAT terminal on the camera side occurs or conductive foreign matter is present between these terminals, it is possible to reduce a likelihood that the accessory-side VDD terminal simultaneously contacts both of these terminals, thereby suppressing short-circuiting between adjacent terminals.

In the present embodiment, the inter-terminal pitch between the VDD terminal 1001 and the VBAT terminal 1002 in the circumferential direction of the camera mount A is increased by 3° relative to the basic pitch. However, the present invention is not limited to this example. At least, it is sufficient that the inter-terminal pitch is increased in a relative rotation direction between the camera mount A and the lens mount B.

Next, in the mount unit 1 according to the present embodiment, the PGND terminal 1004 is disposed at a foremost position in the lens attachment direction on an upper step of the camera mount, and the PGND terminal 2004 is disposed at a foremost position in the lens attachment direction on a lower lens-mount step.

The PGND terminal 2004 on the lens mount B has a contact surface having a width larger than the above-described basic width and is a terminal having the largest contact-surface width among a plurality of terminals provided on the lens mount B. In the present embodiment, the width of the contact surface refers to a width of the contact surface toward a direction for detaching the lens mount B from the camera mount A (detachment direction) on the basis of a location electrically connected between corresponding terminals (connection point). This detachment direction is synonymous with a front side in the lens attachment direction of the lens mount B. The width of the contact surface may be defined simply as a width of the contact surface toward the direction (detachment direction) for detaching the lens mount B from the camera mount A on the basis of a center of the contact surface in the circumferential direction of the mount.

Due to this configuration, the PGND terminal 2004 is a terminal that is first electrically connected to its corresponding terminal among all the terminals when the first interchangeable lens 200 is attached to the camera body 100. The PGND terminal 2004 is a terminal that is finally electrically disconnected from its corresponding terminal among all the terminals when the first interchangeable lens 200 is detached (disengaged) from the camera body 100.

For example, assume that a PGND terminal is disposed further toward a rear side in the lens attachment direction than power-supply terminals (VDD terminal and VBAT terminal). In this case, for example, when the first interchangeable lens 200 is detached from the camera body 100, the PGND terminal of the lens mount may slide against the power-supply terminal of the camera mount. Depending on a speed at which the first interchangeable lens 200 is rotated in the detachment direction, the PGND terminal of the lens mount may momentarily contact a power-supply terminal of the camera mount. Thus, due to the above problem, the output of a camera power supply unit 103 of the camera body 100 described later connected to the power-supply terminal is short-circuited, potentially causing malfunction relating to power supply or power control.

Assume a configuration in which a PGND terminal is disconnected from a contact surface on the lens-mount side earlier than other terminals. In such a case, in particular, if the power-supply terminals on the camera-mount A side and the lens-mount B side have not yet been disconnected and power supply from the camera body 100 is maintained while the PGND terminals are disconnected, malfunction may occur in either device.

To address the above-described problems, in the mount unit 1 according to the present embodiment, when the first interchangeable lens 200 is attached to or detached from the camera body 100, the PGND terminal 2004 of the lens mount B does not slide against (does not contact) any terminal other than the PGND terminal 1004 of the camera mount A. This configuration can reduce a likelihood that the power-supply terminals (VDD terminal and VBAT terminal) of the camera mount A momentarily contact the PGND terminal 2004 of the lens mount B, thereby suppressing short-circuiting between these terminals.

In the mount unit 1 according to the present embodiment, among all the terminals described above, the PGND terminals of the camera mount and the lens mount are connected first when the accessory is attached to the camera and are disconnected last when the accessory is detached from it. In other words, when the accessory is detached (disengaged) from the camera side, the PGND terminals maintain a connected state between the camera-side mount and the lens-side mount until other corresponding terminals are disconnected. This configuration can avoid so-called ground floating, in which the PGND terminals are disconnected while power supply is maintained, thereby reducing malfunction in both apparatuses.

As illustrated in FIG. 5C, in the camera mount A and the lens mount B, an inter-terminal pitch between the PGND terminal 1004 and the adjacent TYPE terminal 1003 is larger than the above-described basic pitch (W2 >W1). More specifically, the inter-terminal pitch between the PGND terminal 1004 and the TYPE terminal 1003 is increased by approximately the same amount as the increase in the width of the contact surface of the PGND terminal 2004 toward the direction (detachment direction) for detaching the lens mount B relative to the basic width. This configuration can reduce simultaneous contact of the PGND terminal 2004 with both the PGND terminal 1004 and the TYPE terminal 1003 caused by making the PGND terminal 2004 of the lens mount B wider than the basic width, thereby suppressing short-circuiting between adjacent terminals.

Next, as illustrated in FIGS. 5A, 5B, and 5C, in the mount unit 1 according to the present embodiment, the MIF terminal 1005 is located at the rearmost side in the lens attachment direction on the lower camera-mount step, and the conductive member 2005 is disposed at the rearmost side in the lens attachment direction on the upper lens-mount step. This configuration can suppress wear on the MIF terminal, which is a terminal for detecting the attachment state of lens mount B relative to camera mount A and is an important terminal that triggers the start and end of communication between the camera and accessory.

Next, as illustrated in FIGS. 5A, 5B, and 5C, in the camera mount A according to the present embodiment, the DGND terminal 1012 is disposed at the frontmost side in the lens attachment direction on the lower camera-mount step, and the CS terminal 1011 is disposed adjacent to the DGND terminal 1012. In the lens mount B according to this embodiment, the DGND terminal 2012 is disposed on the frontmost side on the upper lens-mount step in the lens attachment direction, and the CS terminal 2011 is disposed adjacent to the DGND terminal 2012. Details of the arrangement of the CS terminal will be described later. As described above, the DGND terminal is disposed on the frontmost side in the lens attachment direction, in consideration of the easy processing for physically connecting the metal portion of the mount to ground.

Next, as illustrated in FIGS. 5A, 5B, and 5C, in the mount unit 1 according to the present embodiment, a group of terminals of the first communication unit (the LCLK terminal, the DCL terminal, and the DLC terminal) is disposed adjacent to the MIF terminal. In the mount unit 1 according to the present embodiment, the group of terminals corresponding to the first communication unit is disposed further toward the rear side in the lens attachment direction than groups of terminals corresponding to the second and third communication units.

Due to this configuration, in the lower camera-mount step and the upper lens-mount step, wear of terminals corresponding to the first communication unit following the MIF terminal 1005 can be suppressed. Then, among communications executed between the camera side and the lens side, wear of the group of terminals corresponding to the first communication unit that performs the particularly important first communication can be suppressed more effectively than that of other communication terminals.

Next, as illustrated in FIGS. 5A, 5B, and 5C, in the mount unit 1 according to the present embodiment, the DLC2 terminal 1009 is disposed adjacent to the group of terminals corresponding to the first communication unit on the lower camera-mount step. In the mount unit 1 according to the present embodiment, the DLC2 terminal 2009 is disposed adjacent to the group of terminals corresponding to the first communication unit on the upper lens-mount step.

As described above, when the first interchangeable lens 200 is attached to the camera body 100, the conductive member 2005 is capable of electrically connecting the mount housing 1013 and the MIF terminal 1005. This electrical connection can detect the attachment of the accessory by setting a voltage level indicated by the MIF terminal to low. Prior art provides a dedicated terminal to detect that the accessory is attached to the camera body 100. Eliminating this terminal and using the conductive member 2005 to establish electrical conduction between the MIF terminal 1005 and the mount housing 1013 can achieve the accessory with a simple configuration, and can reduce cost.

### SECOND EMBODIMENT

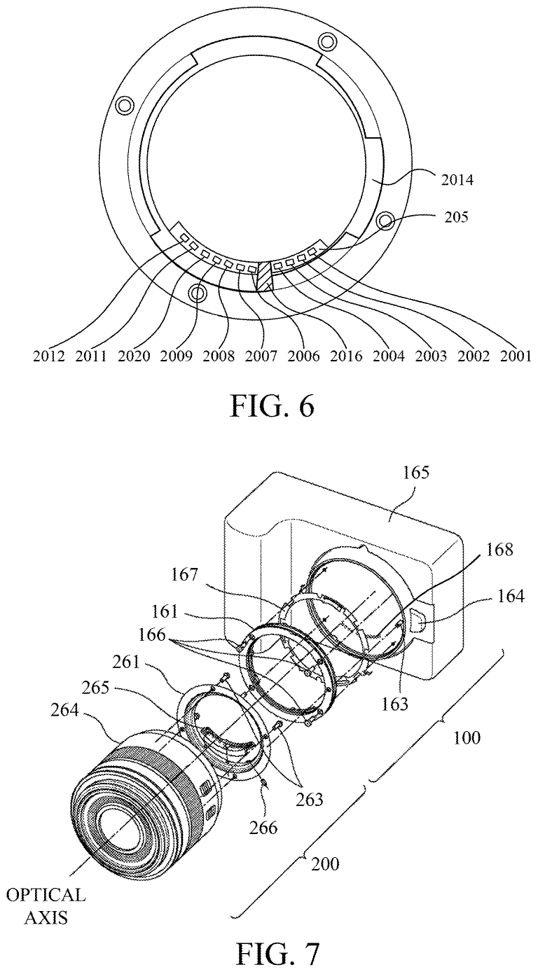

Next, a second embodiment according to the present disclosure will be described with reference to FIG. 6. FIG. 6 is a diagram illustrating, by way of example, a configuration of the lens mount B according to the present embodiment. When the first interchangeable lens 200 is attached to the camera body 100, a conductive member (conductive portion) 2016 electrically connects the mount housing 1013 of the camera body 100 and the MIF terminal 1005. Establishing the electrical conduction can detect the attachment of the accessory (accessory apparatus) by setting a voltage level indicated by the MIF terminal to low.

Prior art provides a terminal to detect that the accessory is attached to the camera body 100. On the other hand, each embodiment eliminates this terminal, uses the conductive member 2016 to establish electrical conduction between the MIF terminal 1005 and the mount housing 1013, and can achieve the accessory with a simple configuration and reduce cost.

In the first embodiment, the accessory mount housing and the conductive member 2005 are made of the same material (such as a metal material, which may include non-metal components as long as a main component is metal), but the present embodiment forms the conductive member 2016 as a member different from the mount housing (coupling portion) 2014. For example, the mount housing 2014 formed of a resin material (which may include non-resin components as long as a main component is resin) and the small conductive member 2016 are used. In the first embodiment, the entire accessory mount housing is made of metal, which tends to increase cost. On the other hand, in the present embodiment, the mount housing 2014 is made of resin, and electrical conduction between the mount housing 1013 of the camera body 100 and the MIF terminal 1005 of the camera can be achieved by the small conductive member 2016. Therefore, the present embodiment can further reduce an amount of metal used, and can further reduce cost.

FIG. 7 is an exploded perspective view illustrating an example of a mount units of the camera body 100 and the accessory according to each embodiment. Here, the first interchangeable lens 200 is illustrated as an example of the accessory, but the configuration is also applicable to other accessories. A camera mount 161 is fixed to a housing 165 of the camera body 100 by four screws 166 via a mount biasing member 167. The mount biasing member 167 is a member that generates a biasing force for pulling bayonet claws, described later, of a lens mount 261 toward the camera mount side. A camera terminal portion 168 is fixed to the housing 165 such that the camera terminal portion 168 is disposed inside the camera mount 161.

The housing 165 holds a lock pin 163 as a protrusion so that the lock pin 163 can move between a protruding position in which the lock pin 163 protrudes from a mount surface (camera mount surface) of the camera mount 161 toward an object side (lens side) and a retracted position in which the lock pin 163 is retracted further toward an image side. The lock pin 163 is biased by a spring toward the protruding position. The camera mount 161 is provided with three bayonet claws spaced apart in the circumferential direction. When the first interchangeable lens 200 is detached from the camera body 100, a user presses a release operation member 164 provided on the camera body 100 to move the lock pin 163 from the protruding position to the retracted position.

On the other hand, a lens mount 261 is fixed to a lens barrel 264, which serves as a housing of the first interchangeable lens 200, by four screws 263. The lens mount 261 includes a mount surface (lens mount surface) and three bayonet claws serving as coupling portions and spaced apart in the circumferential direction.

A lens terminal portion (a second terminal portion and a holder) 265 is fixed to an inner peripheral portion of the lens mount 261 by a plurality of screws 266.

In each embodiment, a mount apparatus (accessory mount) includes the lens mount 261, the lens terminal portion 265, the four screws 263, and the plurality of screws 266. The second mount portion corresponds to the lens mount 261, and bayonet claws and a conductive member are provided on the second mount portion.

As described above, the accessory mount (200, 300, 400, 500) according to each embodiment is attachable to and detachable from the camera mount and includes the second terminal portion (terminals 2001 to 2004 and 2006 to 2012) and the holder. The second terminal portion contacts the first terminal portion (terminals 1001 to 1012) of the camera mount when the accessory mount is attached to the camera mount. The holder holds the second terminal portion. The second terminal portion includes the plurality of terminals (terminals 2001 to 2004 and 2006 to 2012) that contact only a part of the plurality of terminals (terminals 1001 to 1012) of the first terminal portion. The holder includes the conductive portion (conductive members 2005 and 2016) that contacts, when the accessory mount is attached to the camera mount, the first terminal among the plurality of terminals of the first terminal portion that does not contact the plurality of terminals of the second terminal portion. Here, the phrase “contact only a part” means that at least one terminal among the plurality of terminals of the camera mount does not contact any terminal of the accessory mount (that is, the number of terminals of the accessory mount is smaller than the number of terminals of the camera mount). This phrase does not mean that one terminal of the camera mount and one terminal of the accessory mount partially contact each other (that is, contact over an entire area does not occur).

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can provide an accessory mount with a simpler configuration.

This application claims the benefit of Japanese Patent Application No. 2025-066020, filed on Apr. 14, 2025, which is hereby incorporated by reference herein in its entirety.

What is claimed is:

1. An accessory mount attachable to and detachable from a camera mount, the accessory mount comprising:
a second terminal portion configured to contact a first terminal portion of the camera mount while the accessory mount is attached to the camera mount; and
a holder configured to hold the second terminal portion,
wherein the second terminal portion includes a plurality of terminals configured to contact only a part of a plurality of terminals of the first terminal portion, and
wherein the holder includes a conductive portion configured to contact, while the accessory mount is attached to the camera mount, a first terminal among the plurality of terminals of the first terminal portion that does not contact the plurality of terminals of the second terminal portion.

2. The accessory mount according to claim 1, wherein the conductive portion is not grounded while the accessory mount is not attached to the camera mount.

3. The accessory mount according to claim 1, wherein the conductive portion is not connected to a ground terminal via a resistor while the accessory mount is not attached to the camera mount.

4. The accessory mount according to claim 1, wherein the conductive portion is grounded while the accessory mount is attached to the camera mount.

5. The accessory mount according to claim 1, wherein the first terminal is used to detect that the accessory mount is attached to the camera mount.

6. The accessory mount according to claim 1, wherein the first terminal is used to start communication between the camera mount and the accessory mount.

7. The accessory mount according to claim 1, wherein the first terminal is used to start power supply from the camera mount to the accessory mount.

8. The accessory mount according to claim 1, wherein the conductive portion has a shape different from shapes of the plurality of terminals of the second terminal portion.

9. The accessory mount according to claim 1, wherein the plurality of terminals of the second terminal portion are arranged on a same circumference of a second mount portion.

10. The accessory mount according to claim 1, wherein the holder includes a coupling portion coupled with the camera mount while the accessory mount is attached to the camera mount.

11. The accessory mount according to claim 10, wherein the conductive portion and the coupling portion are formed of a same metal material.

12. The accessory mount according to claim 10, wherein the conductive portion and the coupling portion are formed of different materials.

13. The accessory mount according to claim 12, wherein the conductive portion is formed of a metal material, and the coupling portion is formed of a resin material.

14. The accessory mount according to claim 1, wherein the conductive portion electrically connects the camera mount and the first terminal while the accessory mount is attached to the camera mount.

15. The accessory mount according to claim 1, wherein the plurality of terminals of the second terminal portion include two terminals that are adjacent to each other and have different heights.

16. The accessory mount according to claim 15, wherein the conductive portion is disposed between the two terminals.

17. An accessory comprising:
the accessory mount according to claim 1; and
a lens.

18. An accessory comprising:
the accessory mount according to claim 1,
wherein the accessory is attachable to and detachable from a lens apparatus.

19. A camera mount comprising:
the first terminal portion,
wherein the camera mount is attachable to and detachable from the accessory mount according to claim 1.

20. An image pickup apparatus comprising:
the camera mount according to claim 19; and
an image sensor.
